(19) United States
(12) Patent Application Publication
(10) Pub. No.: US 2008/0196992 A1
(43) Pub. Date: Aug. 21, 2008

(54) Pulley Assembly for an Electromagnetic Power Transmitting Assembly

(75) Inventor: Ryszard Ostrowski, Mississauga (CA)

Correspondence Address: MAGNA INTERNATIONAL, INC., 337 MAGNA DRIVE, AURORA, ON, L4G-7K1, CA

(73) Assignee: MAGNA POWERTRAIN INC., Concord, ON (CA)

(21) Appl. No.: 11/917,021

(22) PCT Filed: Jun. 13, 2006
(86) PCT No.: PCT/CA2006/000970

§ 371 Date: Dec. 10, 2007

Related U.S. Application Data
(60) Provisional application No. 60/689,852, filed on Jun. 13, 2005.

(51) Int. Cl. F16D 27/06

(52) U.S. Cl. 192/84.961

(57) ABSTRACT

A pulley integrally has a hub, an outer rim and a flange joining the hub and outer rim. A flux ring is press fitted to the inside surface of the outer rim. The flux ring has an inner diameter sized to closely encircle an electromagnetic coil mounted on a compressor housing. The pulley assembly provides a simple method of providing different sized pulleys for a compressor, enabling different sized engines to utilize a common compressor.

### FIELD OF THE INVENTION

This invention relates to a pulley assembly for an electromagnetic power transmitting assembly. In particular, this invention relates to a pulley having a flux carrier wherein the pulley can be sized to meet various engine configurations while maintaining a configuration for effective transfer of magnetic forces.

### BACKGROUND OF THE INVENTION

On an automotive engine, it is common to provide an air conditioning compressor that is selectively driven by a serpentine accessory drive belt. The compressor can be provided with an electromagnetic coupling that selectively couples the drive to the compressor. The electromagnetic coupling is energized to engage and drive the compressor.

U.S. Pat. No. 5,667,050 discloses an example of a conventional electromagnetic power transmitting assembly. The assembly of the '050 patent has a pulley structure that rotates on a ball bearing assembly about the input shaft of the compressor. The power transmitting assembly also has a magnetic coil that generates a field of magnetic flux when energized by electric supplied from clutch controller.

In order to increase or decrease the diameter of pulley structure in the type of electromagnetic coupling apparatus disclosed in the '050 patent, there are several methods that can be used. The procedure of increasing the diameter of the pulley structure by a relatively small increment usual includes the addition of material to the pulley outer periphery. Additional thickness of the material is limited by the formability of the steel and initial thickness of the material used to produce the pulley.

Furthermore, if the pulley outer diameter must be increased by a large increment beyond the limits of the thickness range of the pulley outer annular portion, there are several methods that can be used. One method increases the diameter of both the pulley outer periphery as well as the coil cavity. Using this method the coil housing outside diameter must be proportionally increased with inside diameter of pulley coil cavity.

Another option to increase the diameter of the pulley outer periphery by large increment is to add an annular flux carrier ring-shaped and then attached to the pulley structure by welding, as described in U.S. Pat. No. 4,935,713.

Another method of increasing the diameter of the pulley is described in U.S. Pat. No. 5,445,256. This method involves the forming of magnetic flux frame into a U-shape and attaching flux frame to the pulley by laser or electron-beam welding.

U.S. Pat. No. 3,455,421 discloses an arrangement wherein a U-shaped metal member is attached to the rear face of the coil.

U.S. Pat. No. 6,394,252 discloses flux carrier mounted to the compressor housing. This arrangement allows different pulley assemblies to be mounted on a single sized magnetic coil. However, this arrangement requires the compressor manufacturer to reconfigure the flux carrier if other pulleys are to be utilized.

All methods of attachment of the flux carrier to the pulley constriction of pulley to the flux carrier are achieved by welding process to fuse metal components of pulley assembly.

### SUMMARY OF THE INVENTION

There exists a need for an improved pulley assembly in which a magnetic carrier or flux ring is nested within a pulley cavity, which magnetic carrier may be configured to fit various diameter pulleys while maintaining a desired fit with an electromagnetic coupling. The pulley assembly provides a simple method of providing different sized pulleys for a compressor, enabling different sized engines to utilize a common compressor.

According to one aspect of the invention there is provided a pulley assembly comprising a pulley having cavity defined by a central hub and an outer rim having poly v configuration. A flux ring is press fitted within the cavity and optionally staked to permanently retain the flux ring in the cavity. The flux ring has an inner diameter that is sized to closely encircle a magnetic coil and an outer diameter that is sized to be press fitted within the cavity. The inner diameter is constrained at a first portion of the flux ring and the outer diameter is constrained at a second portion of the flux ring enabling the flux ring to have a stepped configuration.

According to another aspect of the invention, there is provided a method of forming a pulley assembly. The method comprises the steps of:

roll forming a pulley having a hub, an outer rim and a flange joining said hub and outer rim, the outer rim, flange and hub defining a cavity;

forming a flux ring having a first portion having an inner diameter and a second portion having an outer diameter, the outer diameter is sized to be press fitted within the cavity of the pulley and the inner diameter is sized to closely encircle an electromagnetic coil; and

press fitting the flux ring within the cavity of the pulley, with the outer diameter of the second portion press fitted against an inner surface of the outer rim.

### DESCRIPTION OF THE DRAWING

In a drawing which illustrates an embodiment of the present invention,

FIG. 1 is sectional view of the pulley assembly of the present invention.

### DESCRIPTION OF THE INVENTION

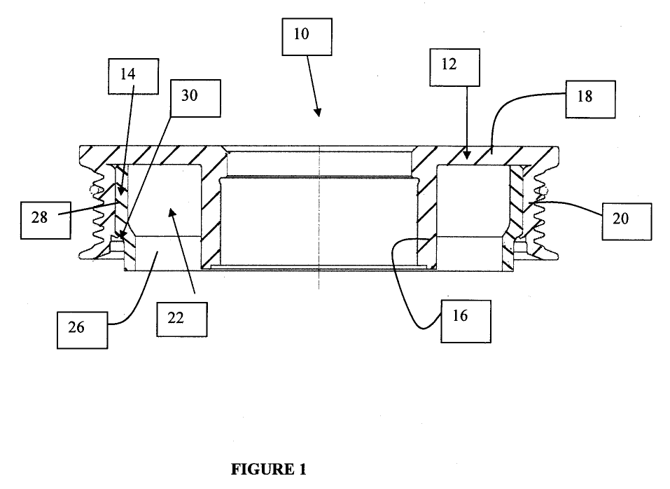

The pulley assembly 10 of the present invention is generally illustrated in FIG. 1. The pulley assembly comprises a cupped shaped pulley 12 and an annular flux ring 14.

Pulley 12 is conventionally made utilizing a roll forming process as described in U.S. Pat. No. 4,273,547. The pulley 12 integrally has an inner hub 16, a web 18 and an outer rim 20, which defines a cavity 22.

The outer diameter of the pulley 12 is determined by the engine specifications and the engine manufacturer. The outer diameter of the hub 16 is determined by the supplier of the air conditioning compressor.

In order for the supplier of the air conditioner compressor to minimize the number of parts required for various engines, the air conditioner supplier requires a uniform hub size. As the outer diameter of the outer rim 20 of pulley 12 increases, the pulley cavity 22 increases. A problem arises in prior art pulley assemblies that the electromagnetic coil positioned within the cavity does not generate a sufficient flux field to engage sufficiently the electromagnetic clutch. A gap is created between inner surface of outer rim 20 and the electromagnetic coil positioned within the cavity 22. The greater the gap, the less effective the electromagnetic clutch is able to provide coupling. The air conditioner supplier is forced to increase the outer diameter of the coil to close the gap, requiring a greater number of coil sizes that must be kept in inventory.

This problem is resolved by the present invention by providing flux ring 14. Flux ring 14 is annular in shape having a first portion 26 and a second portion 28. The first portion 26 has an inner diameter that closely encircles the electromagnetic coil. A desirable gap is about 0.3 to 0.6 mm.

The second portion 28 has an outside diameter that is sized to be press fitted within the cavity 22, on the inside surface of the outer rim 20. Optionally, the outer rim 20 may be staked at circumferentially spaced locations 30 to permanently retain the flux ring 14 within the pulley 12.

The constraining dimensions of the flux ring 14 are the inside diameter of the first portion 26 and the outside diameter of the second portion 28. Thus, in most cases, the flux ring 14 will have a stepped configuration. The transition of the annular ring diameters from the first portion 26 to the second portion 28 is selected to maximize field strength of the magnetic flux from the coil assembly to the flux ring 14.

Preferably, flux ring 14 is stamped from low carbon sheet steel, preferably 1008 to 1010 carbon steel. A ring is formed from the sheet steel. The outside diameter of the ring corresponds to the press fit diameter of the second portion 28. A portion of the ring is then reduced in diameter by press forming to form the first portion 26 so that the inside diameter closely conforms to the outside diameter of the electromagnetic coil.

Material thickness of the flux ring 14 must be sufficient to transfer magnetic fluxes from the electromagnetic coil to the pulley engagement face without losses of the flux density and consequently no losses in magnetic attractive force between clutch engagement friction faces.

As is now apparent to those skilled in the art, the pulley 10 of the present invention could easily be reconfigured to provide a larger or smaller outside diameter depending on the engine design requirements without reconfiguring the electromagnetic coil and/or the compressor housing. Additionally, the same compressor could be utilized on several different sized engines merely by adjusting the outside diameter of pulley 10.

The above-described embodiment of the invention is intended to be an example of the present invention and alterations and modifications may be effected thereto, by those of skill in the art, without departing from the scope of the invention which is defined solely by the claims appended hereto.

What is claimed is:

1. A pulley assembly comprising:
a pulley integrally having a hub, an outer rim and a flange joining said hub and outer rim, said pulley having a cavity defined by said outer rim, flange and hub; and
a flux ring press fitted to said pulley within said outer rim, said flux ring having an inner diameter sized to closely encircle an electromagnetic coil.

2. A pulley assembly as set forth in claim 1, wherein said flux ring and said pulley are staked together.

3. A pulley assembly as set forth in claim 2, wherein said flux ring has a stepped configuration having a first portion having said inner diameter and a second portion having and outer diameter sized to engage with an inner surface of said outer rim.

4. A pulley assembly as set forth in claim 3, wherein said flux ring is low carbon steel.

5. A pulley assembly as set forth in claim 4, wherein said flux ring is formed from a sheet.

6. A method of forming a pulley assembly comprising the steps of:
roll forming a pulley having a hub, an outer rim and a flange joining said hub and outer rim, said outer rim, flange and hub defining a cavity;
forming a flux ring having an inner diameter and an outer diameter, said inner diameter sized to closely encircle an electromagnetic coil and said outer diameter sized to be press fitted within said outer rim; and
press fitting said flux ring with said outer rim of said pulley.

7. A method as set forth in claim 6, wherein said method further comprises a step of staking said flux ring to said pulley.

8. A method as set forth in claim 7, wherein said flux ring is formed by stamping a sheet into a tube having said outside diameter and then press forming a first portion of said tube to have said inside diameter.

9. A method as set forth in claim 8, wherein said outer diameter is press fitted against an inner surface of said outer rim.

10. A method as set forth in claim 9, wherein said flux ring is formed from a low carbon steel base stock.
